(19) United States
(12) Patent Application Publication
(10) Pub. No.: US 2011/0205591 A1
(43) Pub. Date: Aug. 25, 2011

(54) IMAGE PROCESSING DEVICE AND IMAGE PROCESSING METHOD

(75) Inventor: Toru Ushiku, Tokyo (JP)

(73) Assignee: CANON KABUSHIKI KAISHA, Tokyo (JP)

(21) Appl. No.: 13/062,412

(22) PCT Filed: Apr. 11, 2009
(86) PCT No.: PCT/JP2009/069144

§ 371 Date: Mar. 4, 2011

(30) Foreign Application Priority Data
Nov. 10, 2008 (JP) 2008-287943

(51) Int. Cl. G06F 3/12

(52) U.S. Cl. 358/1.15

(57) ABSTRACT

In conventional printing in which image data is page-spooled and printed, the spool memory is increasing with the progression of higher resolutions. Also, there is the problem that it is difficult to guarantee image generating processing that is synchronized with a high-speed print engine in a vector format structure which requires smaller memory capacity. The image data is therefore divided into a plurality of blocks, and an attribute comprising each block is determined. The image generation processing time is predicted based on the attribute information, preparation processing that converts data for image generation such that image generation processing is executed within the printing time is executed based on the prediction result, and image generation processing that is synchronized with a high-speed print engine is guaranteed.

### TECHNICAL FIELD

The present invention relates to an image processing device and control method thereof, and particularly to an image processing device and image processing method for performing parallel processing on image data, synchronizing with an image forming unit (printer engine), and generating an image.

### BACKGROUND ART

In the technical field of multifunctional peripheral devices having copy and printing functions, the speed of the printer engine and the resolution of images are increasing. For this reason, there is a necessity to process a large amount of image data at high speed in an image generating unit that converts image data to print data to be input to the printer engine. There exists technology that realizes an increase in the speed of image generation by providing a plurality of image generating units and executing image generation in parallel.

For example, there is a plurality of image generating processors, and image data is divided into blocks, the attribute of image data for each block and the processing load for image generation according to that attribute are calculated, and each block is grouped into the number of image generating processors such that the overall load is approximately equal. Each image generating processor realizes only image generation processing comprised of image generation algorithms necessary for the image data assigned to each block by the grouping. Image data of each block is provided to each image generating processor that executes that image generation processing, and the speed of image generation is increased by executing image generation in parallel (refer to, for example, Patent Reference 1).
[Patent Reference 1] Japanese Patent Laid-Open No. 2007-81795

However, in increasing the speed of image generation of high-resolution image data, a large amount of image data space is necessary to spool the image data in units of pages. For this reason, there has been the problem that image generation must be done in consideration of the printing speed of the printer engine.

### DISCLOSURE OF INVENTION

The present invention was made in consideration of the aforementioned example of convention, and provides at low cost a high-speed image processing device and image processing method that eliminates the necessity to spool image data as bitmap data in units of pages.

In order to solve the aforementioned problems, the present invention has the following composition.

According to an aspect of the present invention, an image processing device, comprises: dividing means for dividing original image data into a plurality of blocks; attribute determining means for determining a block attribute for each divided block; predicting means for calculating a predicted amount of time necessary for image generation processing that generates output format image data suitable for an image forming unit from the original image data based on the block attribute and the processing time of a block unit; preparation processing means for converting image data of any of the plurality of blocks to suitable image data having a block attribute that has a shorter processing time such that image generation processing of the plurality of blocks will be complete within the predetermined time, in the case that the predicted time exceeds a predetermined amount of time; sorting means for sorting suitable image data of each the block to a plurality of image generating units that generate the output format image data in units of blocks; and rearranging means for rearranging the output format image data in units of blocks generated by the image generating units to positions corresponding to the original image data before division.

According to another aspect of the present invention, a control method for an image processing device executed by the image processing device, comprises: a dividing step of dividing original image data into a plurality of blocks; an attribute determining step of determining a block attribute for each divided block; a predicting step of calculating a predicted amount of time necessary for image generation processing that generates output format image data suitable for an image forming unit from the original image data based on the block attribute and the processing time of a block unit; a preparation processing step of converting image data of any of the plurality of blocks to suitable image data having a block attribute that has a shorter processing time such that image generation processing of the plurality of blocks will be complete within the predetermined time, in the case that the predicted time exceeds a predetermined amount of time; a sorting step of sorting suitable image data of each the block to a plurality of image generating units that generate the output format image data in units of blocks; and a rearranging step of rearranging the output format image data in units of blocks generated by the image generating units to positions corresponding to the original image data before division.

According to still another aspect of the present invention, an image processing apparatus, comprises: division means for dividing input image data into a plurality of blocks; attribute determination means for determining a block attribute for each divided block; calculation means for calculating a predicted amount of time necessary for image generation processing that generates image data to be output from the input image data based on the block attribute and the processing time of a block unit; conversion means for converting image data of a block of the plurality of blocks into bitmap data so as to complete the image generation process for the plurality of blocks within a predetermined time frame when the predicted amount of time exceeds time needed to complete output from an engine; and change means for changing the block attribute converted into bitmap data by the conversion means.

According to another aspect of the present invention, an image processing method, comprises the steps of: dividing input image data into a plurality of blocks; determining a block attribute for each divided block; calculating a predicted amount of time necessary for image generation processing that generates image data to be output from the input image data based on the block attribute and the processing time of a block unit; converting image data of a block of the plurality of blocks into bitmap data so as to complete the image generation process for the plurality of blocks within a predetermined time frame when the predicted amount of time exceeds time needed to complete output from an engine; and changing the block attribute converted into bitmap data in the converting step.

According to the present invention, it is possible to provide at low cost a high-speed image processing device and control method thereof that eliminates the need to spool in units of pages image data converted to a format that can be processed by an image forming unit.

### BRIEF DESCRIPTION OF DRAWINGS

FIG. 1 is the structure of the system according to the present embodiment.

FIG. 2 is a block diagram illustrating the controller according to the present embodiment.

FIG. 3 is a block diagram illustrating in detail the image generation processing unit according to the present embodiment.

FIG. 4 is a flow diagram illustrating data creation processing for image generation according to the present embodiment.

FIG. 5 is a conceptual diagram illustrating an example of image data according to the present embodiment.

FIG. 6 is a diagram illustrating an example of a block attribute information table according to the present embodiment.

FIG. 7 is a conceptual diagram illustrating an attribute determination result for all blocks of the image data example shown in FIG. 5.

FIG. 8 is a conceptual diagram illustrating processing allocation according to the present embodiment.

FIG. 9 is a flow diagram illustrating image generation processing according to the present embodiment.

FIG. 10 is a flow diagram illustrating in detail data sorting processing for image generation according to the present embodiment.

FIG. 11 is a conceptual diagram of sorting according to the present embodiment.

FIG. 12 is a flow diagram illustrating in detail image generation processing according to the present embodiment.

FIG. 13 is a flow diagram illustrating in detail output processing according to the present embodiment.

FIG. 14 is a flow diagram illustrating in detail preparation processing according to the present embodiment.

FIG. 15 is a conceptual diagram of conversion to print data according to the present embodiment.

FIG. 16 is a conceptual diagram illustrating an attribute determination result of a block according to the present embodiment.

FIG. 17 is a conceptual diagram illustrating processing allocation according to the present embodiment.

FIG. 18 is a flow diagram illustrating in detail preparation processing according to the present embodiment 2.

### BEST MODE FOR CARRYING OUT THE INVENTION

### First Embodiment

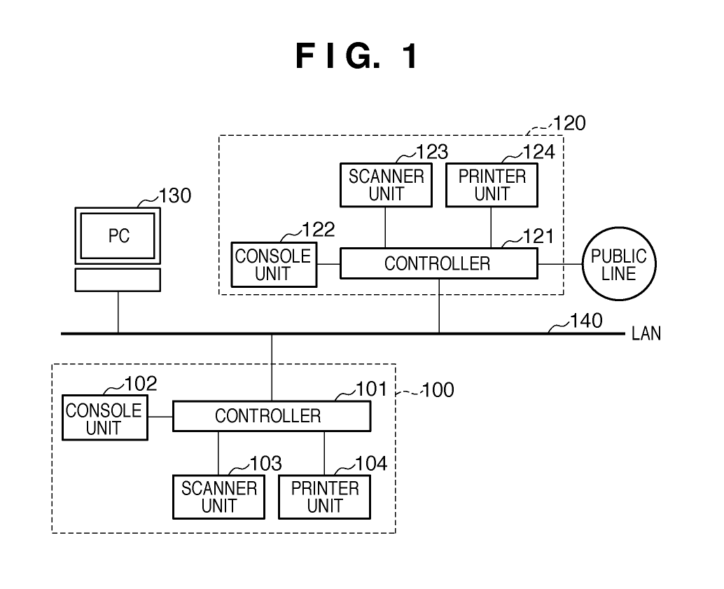

Hereinafter, a preferred configuration for implementing the present invention will be explained based on an embodiment with reference to the figures. FIG. 1 is a diagram showing the structure of the image forming system according to an embodiment of the present invention. Although a host computer 130 and two image processing devices 100, 120 are connected to a LAN 140 in this system, the number of connections is not limited in the image forming system according to the present embodiment. Furthermore, although a LAN is adopted as the connection method in the present embodiment, there is no limitation to this. For example, an arbitrary network such as a WAN (public line), serial transmission method such as USB, or parallel transmission method such as Centronics or SCSI may be adopted.

The host computer (hereinafter called the PC) 130 has the function of a personal computer. This PC 130 can transmit files and electronic mail through a LAN 140 or WAN using the FTP or SMB protocol. Furthermore, the PC 130 can execute printing commands to the image processing devices 100, 120 through a print driver.

The image processing devices 100 and 120 have the same structure, and are image processing devices that have a scanner unit, for example, digital multifunctional peripheral devices. These may also be printing devices (printers) that do not have a scanner unit. Hereinafter, to simplify the explanation, focus will be given to the image processing device 100 of the image processing devices 100, 120, and the structure thereof will be explained in detail. The image processing device 100 is comprised of a scanner unit 103 that is an image input device, a printer unit 104 that is an image output device, a controller 101 that executes overall operational control of the image processing device 100, and a console unit 102 that is a user interface (UI). Because the printer unit also has a mechanism that forms an image based on image data, it is also called an image forming unit.

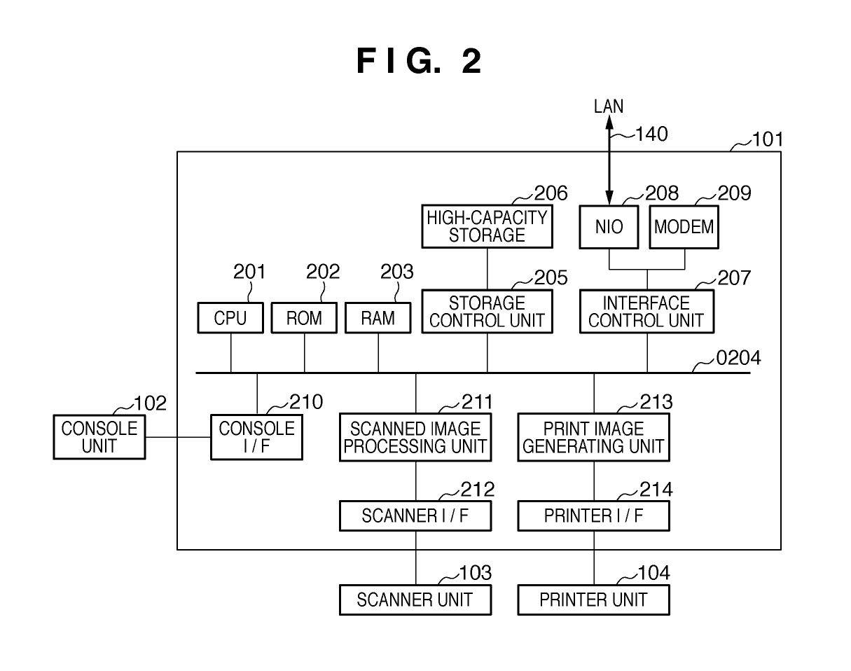

FIG. 2 is a block diagram illustrating the structure of the controller according to the present embodiment. A CPU 201 is a controller for performing overall control of the image processing device 100. The CPU 201 activates an OS (Operating System) by a boot program stored in a ROM 202. Control programs and all application programs stored in a high-capacity storage 206 are executed on this OS. The CPU 201 is connected to each unit by an internal bus such as a data bus 204.

The RAM 203 operates as a temporary storage area such as a main memory or work area, etc., for the CPU 201. Furthermore, it can also be used as a temporary storage area for image processing.

An interface control unit 207 controls a network I/F such as an NIC (Network Interface Card) 208, and executes transmission of all types of data including image data to a network such as a LAN. Also, the interface control unit 207 controls a modem 209, and executes data transmission to a phone line.

A console I/F 210 inputs a user's operational commands from a console unit 102 such as a touch panel or hard key. Also, the console I/F 210 controls a console unit 102 such as an LCD or CRT, and displays a console screen to the user.

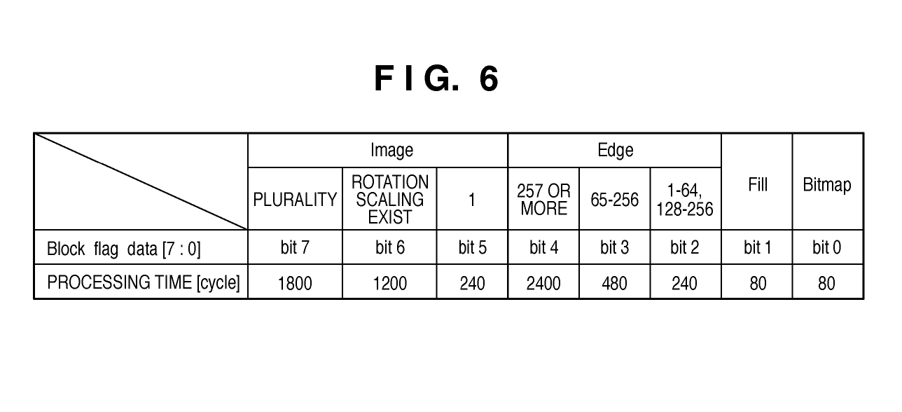

A scanned image processing unit 211 executes correction, processing and editing on image data received from the scanner unit 103 through the scanner I/F 212. Moreover, the scanned image processing unit 211 makes determinations such as whether the received image data is a color original or a black-and-white original, and whether it is a text original or picture original, etc. The result of this determination is then attached to the image data. Information attached in this way is called attribute data. Attribute data will be explained later with reference to FIG. 6.

A print image generating unit 213 generates bitmap data that is image data formatted for output to the printer unit (output format image data), and sends the aforementioned bitmap data to the printer unit 104 through the printer I/F. Moreover, suitable image data of each block generated in the aforementioned CPU 201 is interpreted, and bitmap data generation is executed in the printer image generating unit.

<Image Generating Unit>

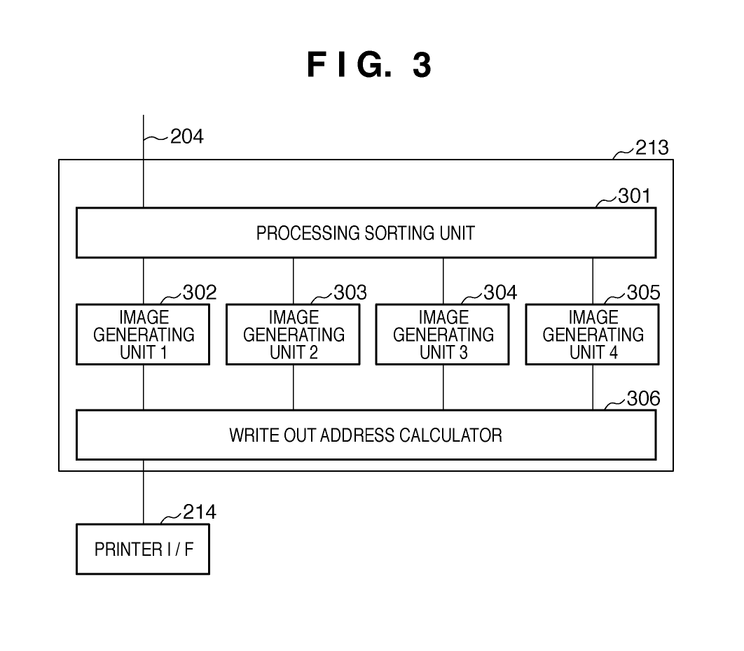

FIG. 3 is a block diagram illustrating in detail the print image generating unit 213. A processing sorting unit 301 executes appropriate allocation of image data created by the CPU 201 and suitable for banding to the image generating units 302, 303, 304, 305. At this time, allocation information is created by the aforementioned CPU 201 similarly to the aforementioned data for image generation.

The image generating units 302, 303, 304, 305 convert image data sorted by the processing sorting unit 301 to an output format for which the image can be image-formed by the printer unit 104, which is image data of a bitmap format in the present example. This image data of a bitmap format is also called output format image data in the present embodiment. It is desirable that the image generating units 302, 303, 304, 305 have identical functions, and can operate in parallel. Also, although four image generating units are provided in FIG. 3, the number of image generating units may be changed.

A write-out address calculator executes print address calculation for a block of bitmap data generated by the image generating units 302, 303, 304, 305, and outputs bitmap data to the printer I/F 214 in accordance with the calculated addresses.

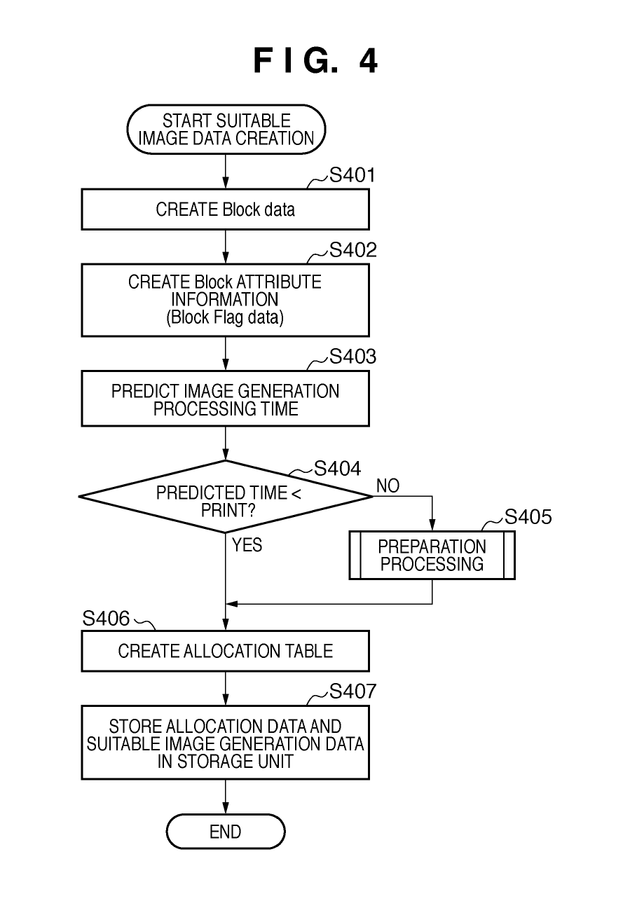

FIG. 4 is a flow diagram illustrating suitable image data creation processing in the present invention. The CPU 201 performs blocking processing on print data received through the interface control unit and stored in a storage device from the PC 130, or print data received from the scanner unit 103 and stored in the storage device (S401). Here, the storage device is a RAM 203 or a high-capacity storage 206.

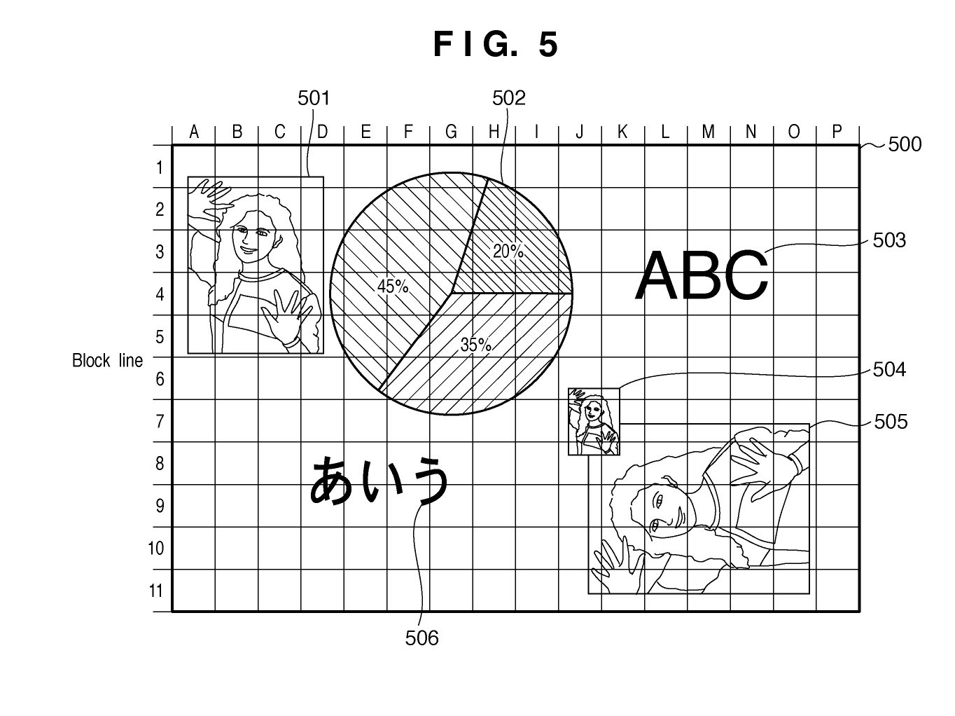

Blocking processing is processing that divides the image data into blocks of a small area. FIG. 5 illustrates an example of image data (original image data) targeted for printing. The image data 500 is comprised of a same-size image 501, a graphic 502, text 503, text 506, a reduced image 504, and a rotated and enlarged image 505. Although the image data 500 is typically comprised of image compositional elements (objects) such as images, graphics and text, etc., and a description of the arrangement thereof, there are also cases of bitmap image data. In addition to the position of the image compositional elements, descriptions of conversions such as rotation and enlargement/reduction (scaling) are also included in the description of the arrangement of the image compositional elements. This image data 500 is divided into 16 from A to P in the horizontal direction, and into 11 from 1 to 11 in the vertical direction for a total of 176 blocks. This is of course only one example, and a division corresponding to the processing power of the image generating units is desirable. During division, objects that straddle two blocks may be converted to an image object, for example, and this may be divided. Here, in the case of an object that has been rotated or scaled, the image object may be converted after execution of that conversion processing and divided into blocks. Of course, if the position of the object on the page and the position of the block on the page are known, the object does not have to be converted to an image object even if it straddles a plurality of blocks, as it can be drawn in units of blocks.

Next, the CPU 201 determines the attribute of each block (attribute determination). That is, the objects included in each block are determined, and the result of the determination is recorded as a block attribute (Block Flag) (S402). Determination of a block attribute is executed based on the compositional elements of the images that exist within each block. Moreover, in the case that an object has undergone rotation or scaling, the block in which that object appears cannot be specified without executing rotation processing or scaling processing. Therefore, for a page including an object that has undergone rotation processing or scaling processing, the block in which the object appears must be specified after executing rotation or scaling processing, and inclusion of an object that has undergone rotation or scaling must be recorded as a block attribute of that block.

Next, the processing time corresponding to each bit of the block attribute and defined in advance is integrated based on the block determination result, and the block processing time is calculated. Furthermore, that block processing time is integrated in units of data sent to the printer unit 104, and the predicted time for image generation processing is calculated (S403). This predicted time may be calculated as an average value for a single image generating unit. Moreover, the prediction for the image generation processing time (S403) is executed for all of the data for image generation in units of bitmap data sent to the printer unit 104 through the printer I/F 214. In the present embodiment, an explanation will be given with one block line (one row of blocks) as the unit of sent bitmap data. Although the image processing device of the present embodiment conserves the necessary amount of buffer by executing buffering processing, one block line corresponds to one band here. That is, a block line corresponds to the width of the original image data. For this reason, the second and thereafter band on the page cannot be generated until printing of the immediately preceding band is completed.

Next, the CPU 201 determines whether or not the predicted time calculated in step S403 is shorter than the predetermined amount of time necessary to print (time necessary for printing) the image data for one block line in the printer unit 114 (S404). In the case that the predicted time exceeds the time necessary for printing in the printer unit 114, preparation processing, to be described later, is executed (S405). Also, in the case that the predicted time is equal to or less than the time necessary for printing (that is, within a predetermined time) in the printer unit 114, processing sorting table creation is executed in the image generating units 302, 303, 304, 305 shown in FIG. 3 (S406).

Next, the CPU 201 stores the data for block image generation created by the blocking processing (S401) and the sorting table created during sorting table creation (S406) in the storage device (RAM 203) (S407) and ends the process.

Moreover, image data that satisfies the conditions in step S404, and image data on which preparation processing has been executed in step S405 are called suitable image data in the present embodiment, since these are image data suitable for banding processing.

<Block Attribute and Block Sorting>

FIG. 6 illustrates an example of a block attribute information table 600 describing a block attribute and created in step S403. The block attribute is comprised of 8 bits, and is associated with each block and saved. The correspondence between block attribute and processing time may be stored separately and in advance in a table. The block attribute is determined by the type of objects included in the block. For example, if an image object is included, bit 5 of the block attribute of that block is set to “1”. If a plurality of image objects are included, bit 7 of the block attribute is set to “1”. If an image object for which rotation or scaling conversion is indicated is included, bit 6 of the block attribute is set to “1”. Also, in the case of an object such as a graphic or text, Flag bits corresponding to the number of borders (number of edges) and fill are set to “1” in order to handle vector data. For example, if the number of edges is between 1 and 64, bit 4 through bit 2 of the block attribute are set to “1” (=001b); if the number of edges is between 65 and 128, bit 4 through bit 2 of the block attribute are set to “2” (=010b); if the number of edges is between 128 and 256, bit 4 to bit 2 of the block attribute are set to “3” (=011b); and if the number of edges is equal to or more than 257, bit 4 through bit 2 of the block attribute are set to “4” (=100b). If there is a fill indication for a graphic or text, bit 1 of the block attribute is set to “1”. If the block is bitmap data, bit 0 of the block attribute is set to “1”.

The predicted time for conversion processing of each block is calculated by integrating the time corresponding to each bit. For example, if the block attribute value is “06”, bit 2 and bit 1 are “1”, and the value of 320 cycles, which is the sum of the corresponding values of 240 cycles and 80 cycles, is calculated as the predicted time.

For example, because the block K1 (the block at the horizontal position X and vertical position N is represented as block XN) in FIG. 5 includes no objects, the corresponding block attribute information is set to “00” (hexadecimal). Because a plurality of images are included in block K8, the corresponding block attribute information is set to “80” (hexadecimal).

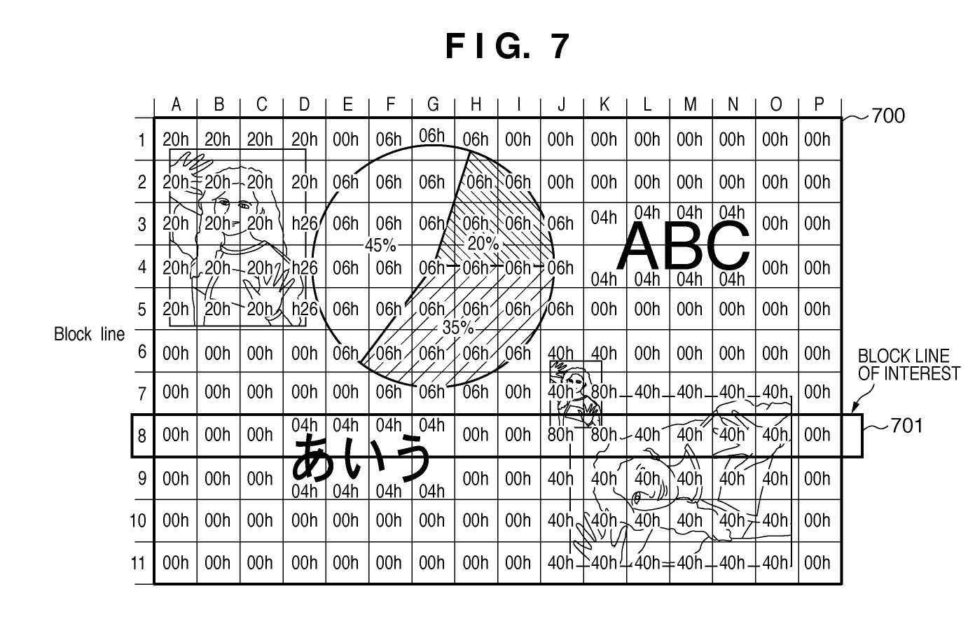

FIG. 7 illustrates the result 700 of executing the block attributes of all blocks of the image data example shown in FIG. 5 based on the block attribute information table 600 shown in FIG. 6.

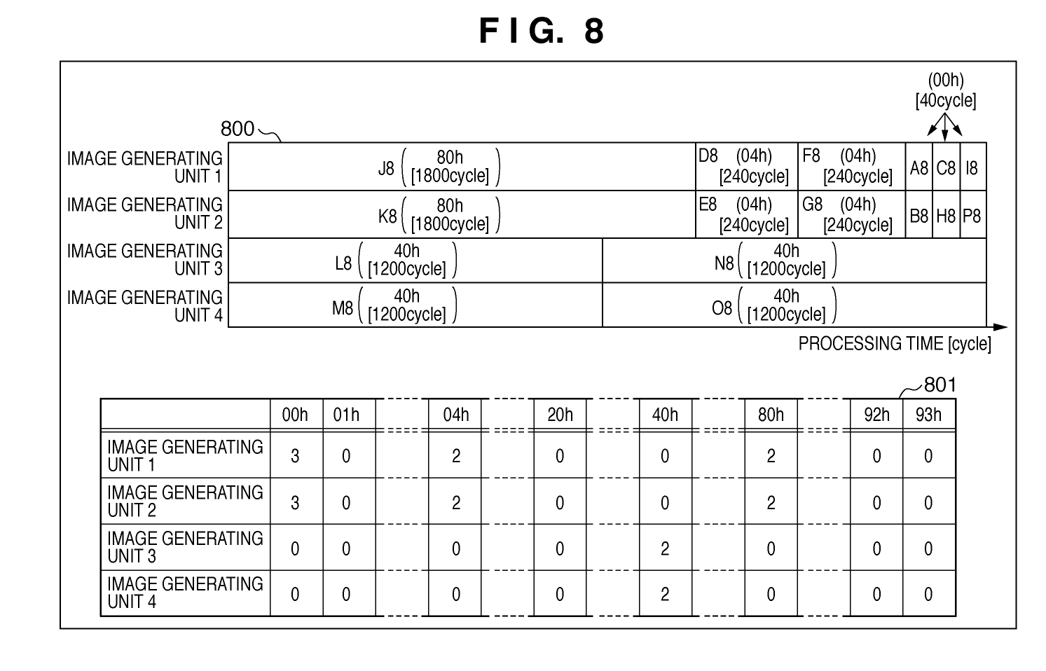

FIG. 8 is a conceptual diagram illustrating the processing sorting of step S406. This is an example in which the block line of interest 701 shown in FIG. 7 is equalized with a focus on the processing times of the image generating units 302, 303, 304, 305, and a sorting table 801 has been created. The concept equalized with a focus on processing time is represented by reference numeral 800. The number of blocks to be processed by each image generating unit is registered for each block attribute in the sorting table. Because the order of block processing in one block line is not a particular problem, the sorting table 801 can be referred to, and blocks having appropriate block attributes can be processed so as not to overlap during image generation processing.

In the present example, one block line is comprised of 16 blocks. Because four image generating units are used, the image generation processing for these 16 blocks is sorted (scheduled) to four image generating units. Regarding the sorting sequence, blocks are sequentially sorted to each image generating unit in a predetermined order starting with the block for which the processing time is longest from within the block line to be processed. At this time, the predicted time of processing corresponding to the blocks sorted to each image generating unit is integrated for each image generating unit, and is compared with the time necessary for printing. If the integrated value exceeds the time necessary for printing, the block cannot be sorted to the image generating unit. Instead, the block is sorted to the next image generating unit. If the integrated value exceeds that time necessary for printing as well, it is sorted to still the next image generating unit. If that block cannot be sorted to any image generating unit, there is a possibility that the bitmap data for that block line cannot be generated within the predetermined time necessary for printing. In this case, the preparation processing of step S405 must be repeated. If sorting of all blocks belonging to one block line is complete, step S406 was successful. Each block is sorted to an image generating unit in this manner.

<Image Generating Processing Procedure>

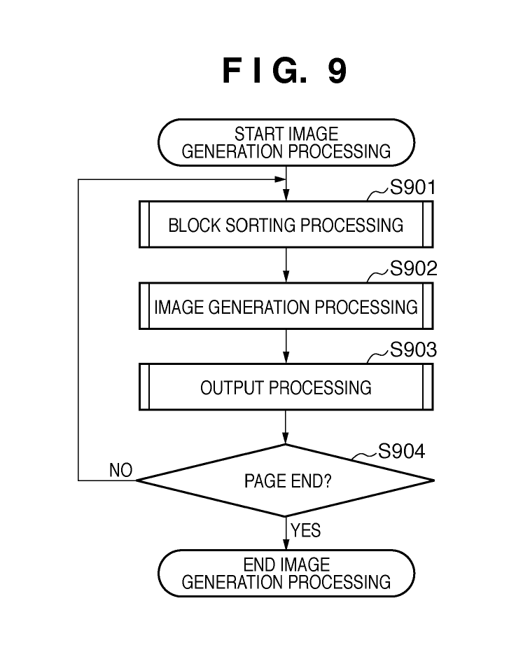

FIG. 9 is a flow diagram illustrating image generation processing in units of pages in the present embodiment. A processing sorting unit 301 in the print image generating unit 213 executes sorting (S901) of suitable image data of each block to the image generating units 302, 303, 304, 305 in accordance with a sorting table.

Next, the image generating units 302, 303, 304, 305 execute image generating processing (S902) that expands image data of each sorted block to bitmap data.

Furthermore, the image generating units 302, 303, 304, 305 perform buffering on the expanded bitmap data at addresses calculated by a write out address calculator 306. In other words, the processing executed here is re-arrangement that writes back a block to a position corresponding to the original image data. Then, output processing (S903) that sends a sending unit of the bitmap data to the printer unit 104 through the printer I/F 214 at the point in time of buffering is executed. The sending unit is one block line in the present example, and corresponds to one band.

Whether or not sending of one page of data is complete is determined (S904), and in the case that it is not complete, the process returns to the block sorting processing (S901), and in the case that it is complete the process ends.

Of course, in the case that printing of a plurality of pages is executed, the processing in FIG. 9 is executed for each page. Because print underrun does not occur even if there is an open time interval between pages, completion of image generation processing within the time necessary for printing may be guaranteed in units of bands.

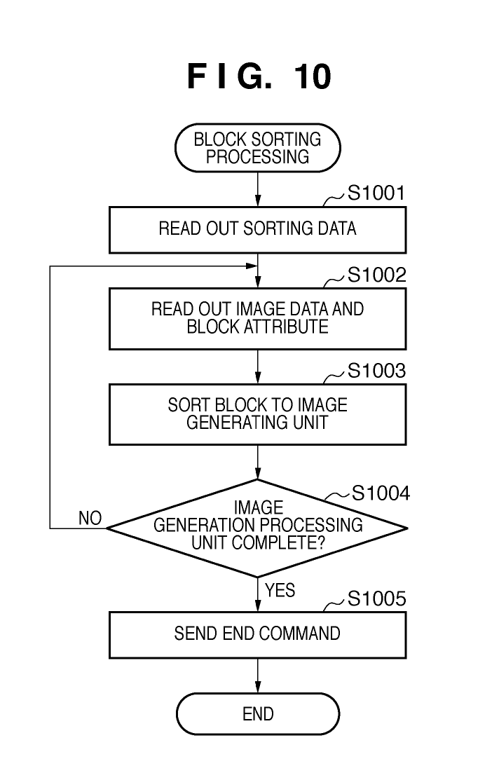

FIG. 10 is a flow diagram illustrating in detail the image data sorting processing (S901) shown in FIG. 9.

The processing sorting unit 301 reads out a sorting table 801 (S1001) from the storage unit (RAM 203). Here, the sorting table 801 is read out in units of bitmap data transfer. In the present embodiment, a unit is one block line.

Next, suitable image data divided into blocks and block attributes are read out (S1002) from the storage unit (RAM 203). Here, the image data is read out in units of the image generating units that execute parallel processing. That is, image data of four blocks is read out at once in the present embodiment.

Next, suitable image data divided into blocks are sorted (S1003) to the image generating units 302, 303, 304, 305 based on the sorting table 801. An example of sorting to an image generating unit will be explained. The number of blocks to be processed by the image generating unit is registered in the sorting table 801 for each block attribute value. Here, if the value of the sorting table 801 corresponding to a read out block attribute is a value other than 0, the block is determined to be processed by that image generating unit. The identification information of that block is then written out as schedule information. In this case, the block attribute value for which allocation is complete is omitted from the sorting table 801.

Thus, the identifier of the blocks to be processed and the processing sequence thereof is recorded as schedule information for each image generating unit.

Whether or not sorting processing for blocks of a unit of bitmap data transfer is complete is determined (S1004), and in the case that it is not complete the process returns to reading out (S1002) of the block attribute and suitable image data. In the case that it is complete, an end command is sent (S1005) to the image generating units 302, 303, 304, 305 and the process ends. Moreover, reading out of the block attribute information only is sufficient in step S802 as long as the identification information of that block can be grasped.

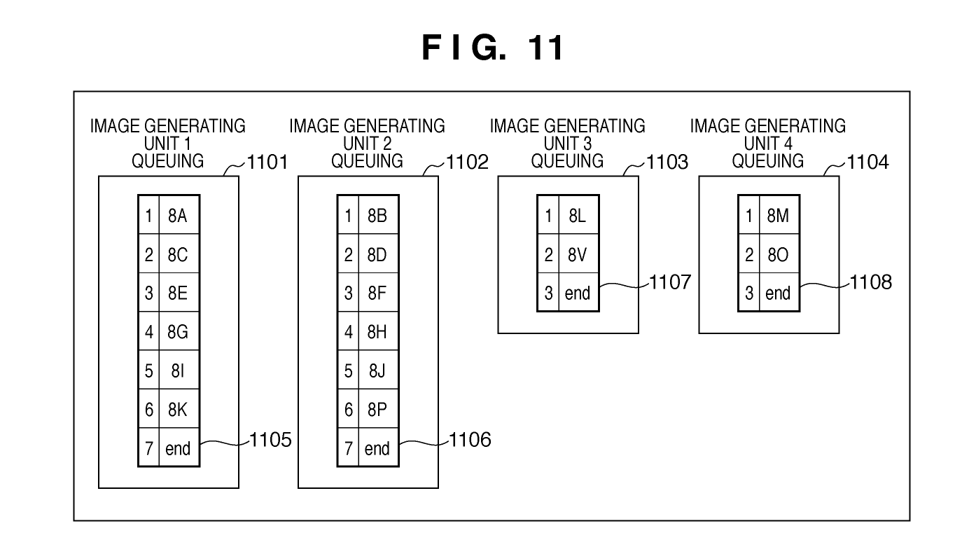

FIG. 11 is a conceptual diagram in which image data of each block is sorted to the image generating units 302, 303, 304, 305 by the processing sorting unit 301. This corresponds to the aforementioned schedule information. A group of blocks of the image data shown in the schedule information 1101 is sorted in the image generating unit 302. That is, the image generating unit 302 executes processing in the order of block 8A, 8C, 8E, 8G, 8I, 8K. Each block must be saved so as to be uniquely identifiable. An identifier may be associated with each block, or the blocks may be stored in a constant order for identification. When the image processing unit reads an end command 1105, the processing temporarily ends. The same is true for the other image generating units. The group of blocks shown in the schedule information 1102 is sorted to the image generating unit 303, the group of blocks shown in the schedule information 1103 is sorted to the image generating unit 304, and the group of blocks shown in the schedule information 1104 is sorted to the image generating unit 305. Also, end commands 1105, 1106, 1107, 1108 are sorted to the last data of the image generating units 302, 303, 304, 305.

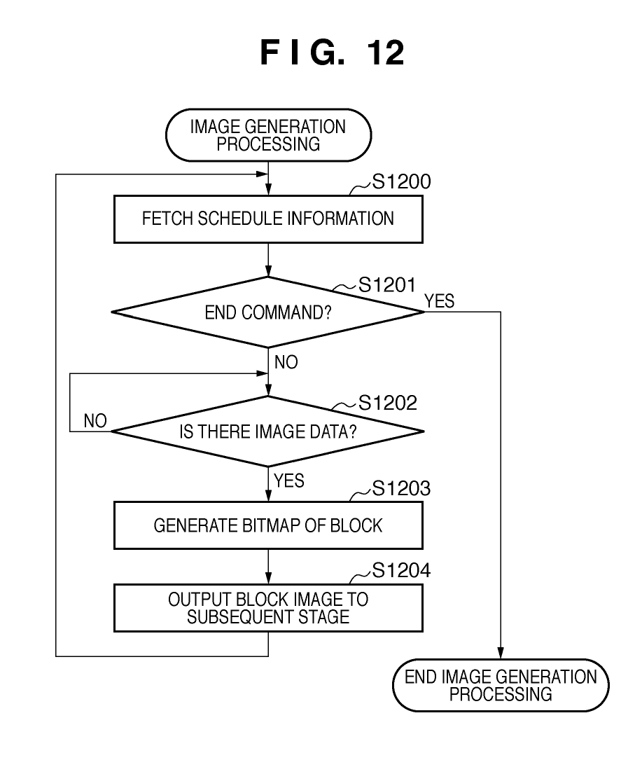

FIG. 12 is a flow diagram illustrating in detail the image generation processing (S902) shown in FIG. 9. This processing is executed in each of the image generating units 302, 303, 304, 305. The image generating units refer to the schedule information 1101 to 1104, and at first fetch the identifier of the front block (S1200). Then, whether or not the fetched identifier is an end command is determined (S1201). In the case that it is determined to be an end command, the process ends. If it is determined not to be an end command, whether or not the image data of that block (called the block of interest) exists in the storage unit is determined (S1202).

In the case that it is determined that image data does not exist, image data is awaited. In the case that it is determined that image data exists, generation processing (S1203) of the bitmap data of the block of interest is executed, the generated bitmap data is output (S1204), and the next schedule information is fetched (S1200).

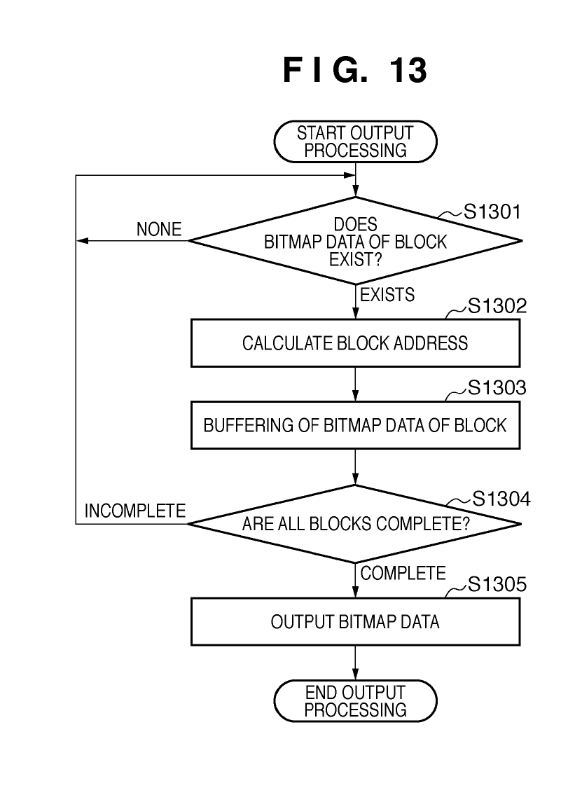

FIG. 13 is a flow diagram illustrating in detail the output processing (S903) shown in FIG. 9. The write out address calculator 306 determines (S1301) whether or not bitmap data of each block (called block bitmap data) formed by the image generating units 302, 303, 304, 305 exists. In the case that it is determined that it does not exist, block bitmap data is awaited. In the case that it is determined that block bitmap data exists, the write out address of the block bitmap data is calculated (S1302), and buffering is performed (S1303). Whether or not processing for blocks of all units of sent bitmap data is complete is determined (S1304), and in the case that it is complete output processing (S1305) of bitmap data of a sending unit to the printer unit 140 through the printer I/F 214 is executed. Furthermore, in the case that it is not complete, block bitmap data is awaited.

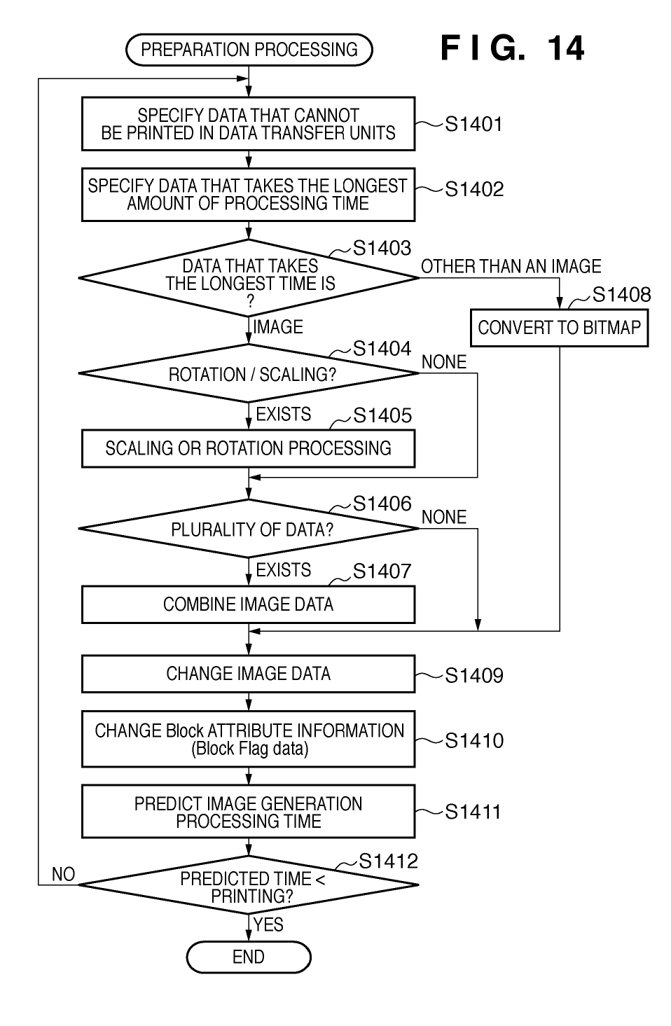

FIG. 14 is a flow diagram illustrating in detail the preparation processing S405 shown in FIG. 4. The preparation processing of the block line of interest 701 shown in FIG. 7 will be explained as an example.

The CPU 201 specifies data that cannot be printed in bitmap data transfer units (S1401) as preparation processing. This specifies block lines that cannot be expanded within the time necessary for printing. In the procedure in FIG. 4, because step S405 is executed only in the case that the block line of interest cannot be expanded within the time necessary for printing, processing to specify a block line that cannot be expanded within the time necessary for printing is not particularly necessary.

Next, the object for which image generation processing will take the longest time from within the block line specified in S1401 is specified (S1402). This is determined based on the processing times corresponding to the attribute values shown in FIG. 6 after referencing the block attributes of each block. For example, because bit 4 (a vector object having 257 or more edges) is the object with the longest processing time, if there is a block that has this attribute in the block line of interest, this block becomes the target for conversion. Of course, if the object straddles a plurality of blocks, those plurality of blocks become targets.

Next, whether or not the object that takes the longest time for processing specified in S1402 is an image object is determined (S1403). If it is an object other than an image object, the image data of that block is converted to bitmap data (S1408). In the case that it is determined to be an image object in step S1403, whether or not there is an accompanying rotation or scaling (enlargement/reduction) conversion is determined (S1404). In the case that there is rotation or scaling, rotation processing or scaling processing is executed (S1405).

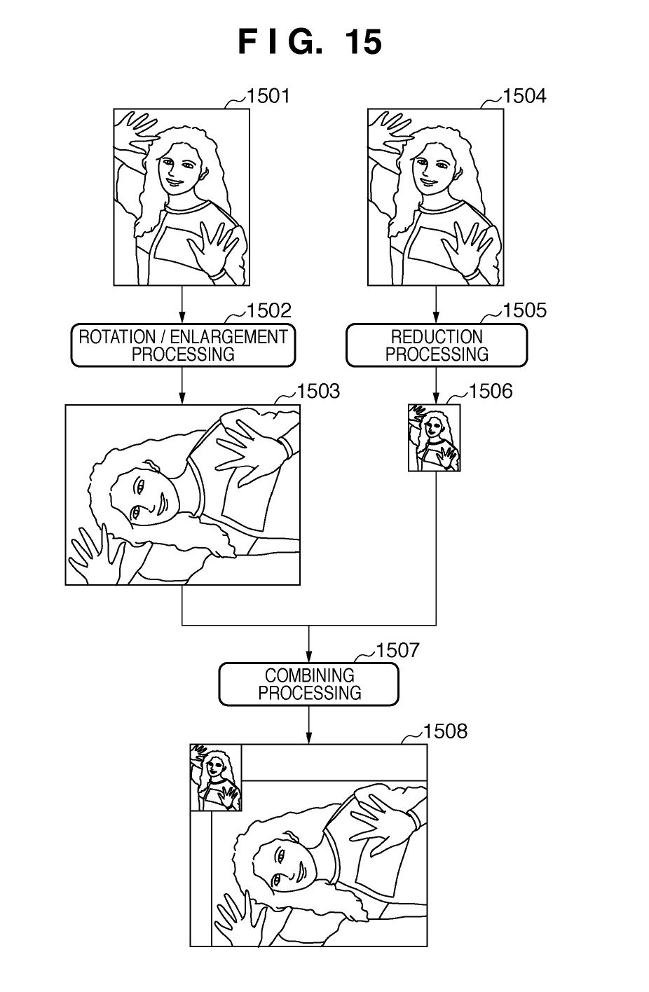

FIG. 15 is a diagram illustrating the concept of conversion to print data. The rotated and enlarged image object 505 shown in FIG. 5 is converted to a simple image object 1503 by executing rotation/enlargement processing 1502 on an image object 1501. Similarly, the reduced image object 504 shown in FIG. 5 is converted to a simple image object 1506 by similarly performing compression processing 1505 on an image object 1504.

Next, whether or not a plurality of image objects exist is determined (S1406), and in the case that they do exist, combination processing (S1407) is executed on the plurality of image objects to convert them to a single image object. In the example of FIG. 15, simple images (1503, 1506) are converted to a single simple image 1508 by combination 1507.

Next, the image data of each block is updated (S1409) by the aforementioned converted objects. For example, if a plurality of image objects were combined into a single image object, the image data is updated such that the single image object after combination is included in the appropriate block, rather than the plurality of image objects before combination. The updated image data becomes the suitable image data. Furthermore, the block attribute information is changed (S1410) in accordance with the image data after conversion.

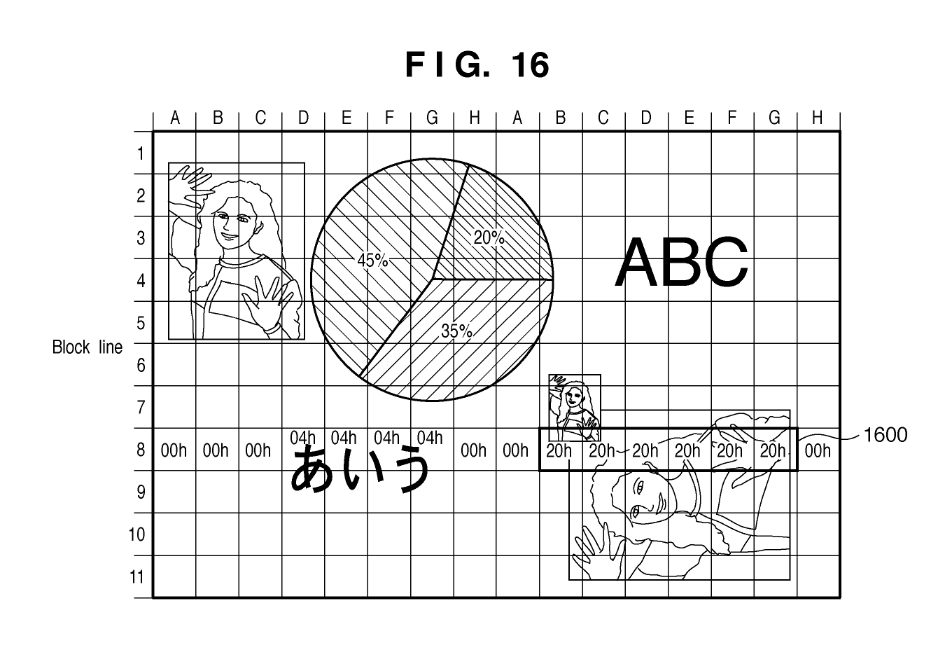

FIG. 16 is an example illustrating block attribute information changed in S1410. Because a reduced image 504 and a rotated/enlarged image 505 have been converted to a simple image 1508, the block attribute information (20h) of the simple image has become as shown by the block attribute 1600.

Next, image generation processing prediction (S1411) is executed based on the block attribute information changed in S1410, and whether the predicted time for image generation processing is shorter than the printing time of the printer unit 114 is determined (S1412). If it is shorter the process ends, and the image data for which blocking is complete at that time is set as the suitable image data. If it is longer, the process returns to step S1401, the next block for which the predicted time for processing is longest is selected, and conversion processing is executed similarly to the above.

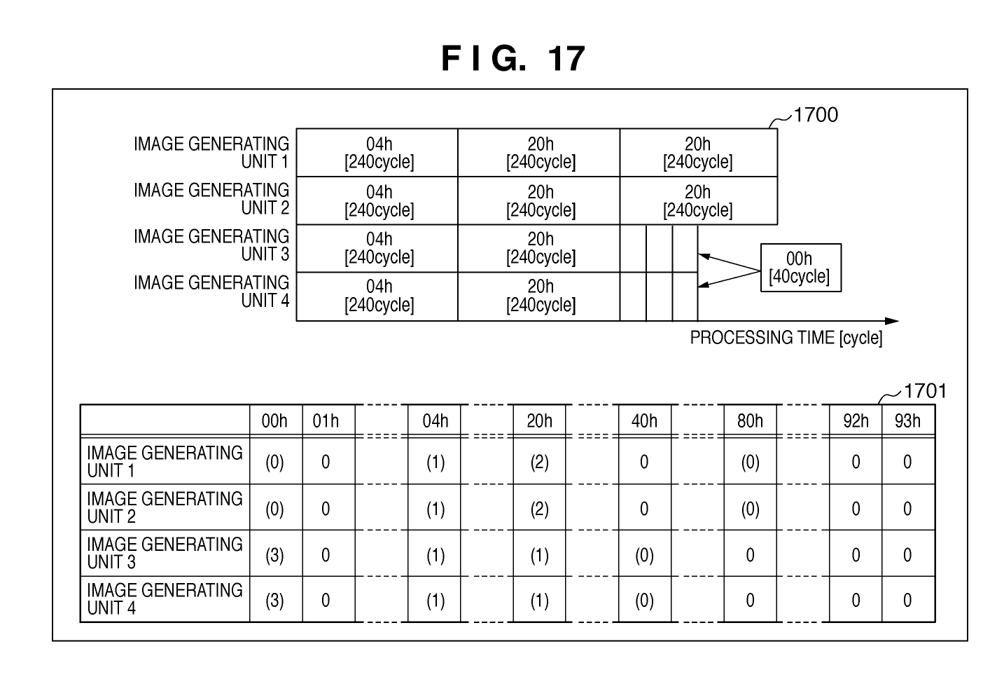

FIG. 17 is a conceptual diagram illustrating processing allocation after preparation processing (S405). This is an example in which the block line of interest 701 shown in FIG. 7 equalized with a focus on the processing time in the image generating units 302, 303, 304, 305, and a sorting table 1701 is created. The concept of equalization with a focus on processing time is shown by reference numeral 1700.

If there is a possibility that generation of bitmap data of one block line cannot be done within the time necessary to print one block line and underrun occurs, the image data of the block line is converted to a format for which the generation processing time of the bitmap data can be reduced. It is thus possible to prevent underrun. According to the present invention, the image processing device does not require spooling bitmap data in page units, hence it is possible to provide an image processing device with a small memory capacity.

### Second Embodiment

Although image data was specified for preparation processing in the first embodiment, the second embodiment is characterized by specifying an image, rather than image data, in units of blocks and converting them.

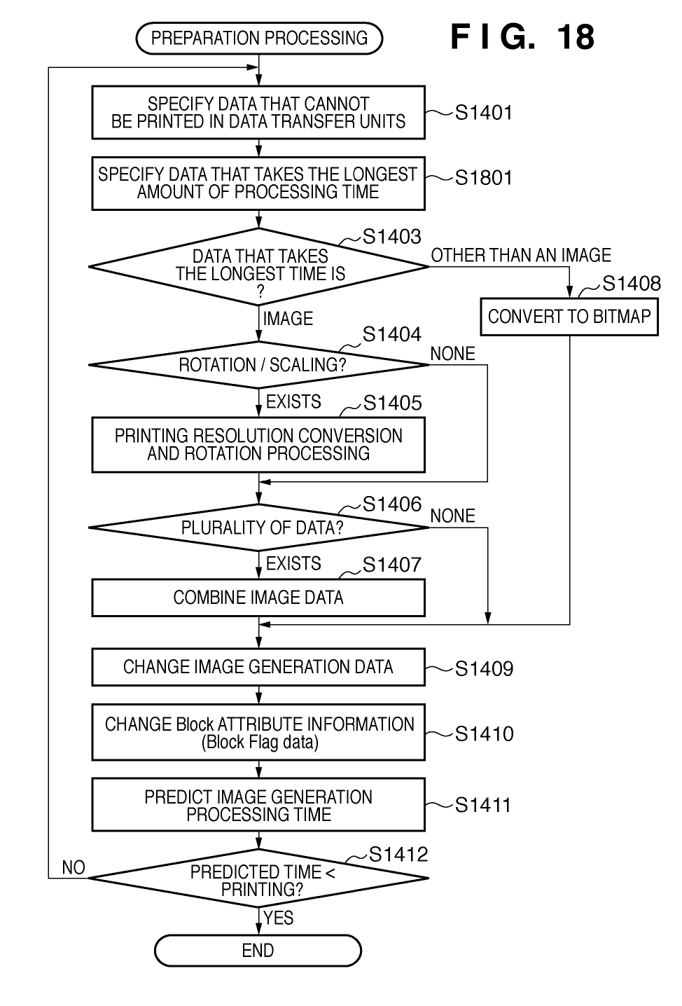

FIG. 18 is a flow diagram illustrating in detail the preparation processing S405 shown in FIG. 4. This will be explained with the preparation processing of the block line of interest 701 shown in FIG. 7 as an example.

During pre-processing, the CPU 201 specifies data that can be printed in bitmap data transfer units (S1401). Here, a block line that cannot be expanded within the time necessary for printing is specified. In the procedure of FIG. 4, however, because step S405 is executed only in the case that the block line of interest cannot be expanded within the time necessary for printing, processing to specify a block line that cannot be expanded within the time necessary for printing is not particularly necessary.

Next, the block for which image generation processing will take the longest time is specified from among those specified in S1401 (S1801). Here, the block attribute of each block is referred to, the processing times corresponding to each attribute value shown in FIG. 6 are integrated in units of blocks, and a determination is made by comparing these with each other. However, if the processing time calculated in step S403 in FIG. 4 has been saved, that value may be referenced.

Next, the block attribute of the block for which the processing time is longest specified in S1402 is referenced, and whether or not an object included therewithin is an image object is determined (S1403). If the object is an object other than an image object, the image data of that block is converted to bitmap data (S1408). In the case that it is determined in S1403 that it is an image object, whether or not there is an accompanying rotation or scaling (enlargement/reduction) conversion is determined (S1404). In the case that there is rotation or scaling, rotation processing or scaling processing is executed (S1405).

FIG. 15 is a diagram illustrating the concept of conversion to print data. The rotated and enlarged image object 505 shown in FIG. 5 is converted to a simple image object 1503 by executing rotation/enlargement processing 1502 on an image object 1501. Similarly, the reduced image object 504 shown in FIG. 5 is converted to a simple image object 1506 by performing reduction processing 1505 on an image object 1504.

Next, whether or not a plurality of image objects exists is determined (S1406), and in the case that they exist, combination processing (S1407) is executed on the plurality of image objects to convert them to a single image object. In the example of FIG. 15, simple images (1503, 1506) are converted to a single simple image 1508 by combination 1507.

Next, image data of each block is updated by the aforementioned converted object (S1409). For example, if a plurality of image objects were combined into a single image object, the image data is updated such that the single image object after combination is included in the appropriate block, rather than the plurality of image objects before combination. The updated image data becomes the suitable image data. Furthermore, the block attribute information is changed (S1410) in accordance with the image data after conversion.

FIG. 16 is an example illustrating block attribute information changed in S1410. Because a reduced image 504 and a rotated/enlarged image 505 are converted to a simple image 1508, the block attribute information (20h) of the simple image becomes as shown by the block attribute 1600.

Next, image generating processing prediction (S1411) is executed based on the block attribute information changed in S1410, and whether the predicted time for image generation processing is shorter than the printing time of the printer unit 114 is determined (S1412). If it is shorter the process ends, and the image data for which blocking is complete at that time is set as the suitable image data. If it is longer, the process returns to step S1401, the next block for which the predicted time for processing is longest is selected, and conversion processing is executed similarly to the above.

According to the present embodiment, the device does not require spooling bitmap data in page units, hence it is possible to provide an image processing device with a reduced memory capacity. Furthermore, a memory capacity of an image processing device can be reduced by converting data for image creation into bitmap data in advance to printing.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-287943, filed Nov. 10, 2008, which is hereby incorporated by reference herein in its entirety.

1. An image processing device, comprising:
dividing means for dividing original image data into a plurality of blocks;
attribute determining means for determining a block attribute for each divided block;
predicting means for calculating a predicted amount of time necessary for image generation processing that generates output format image data suitable for an image forming unit from said original image data based on the block attribute and the processing time of a block unit;
preparation processing means for converting image data of any of said plurality of blocks to suitable image data having a block attribute that has a shorter processing time such that image generation processing of said plurality of blocks will be complete within said predetermined time, in the case that said predicted time exceeds a predetermined amount of time;
sorting means for sorting suitable image data of each said block to a plurality of image generating units that generate said output format image data in units of blocks; and
rearranging means for rearranging the output format image data in units of blocks generated by said image generating units to positions corresponding to said original image data before division.

2. The image processing device according to claim 1, wherein processing that rotates or enlarges/reduces an image object included in the image data in advance is included in the conversion by said preparation processing means.

3. The image processing device according to claim 1, wherein processing that converts a vector object to a bitmap format is included in the conversion by said preparation processing means.

4. The image processing device according to claim 1, wherein image data divided by said dividing means has a format composed of objects, and the image generation processing by said image generating unit includes processing that generates output format image data from input suitable image data.

5. The image processing device according to claim 1, wherein
said predicting means calculates the predicted amount of time necessary for image generation processing of blocks corresponding to the width of said original image data, and
said sorting means sorts suitable data of each said block to said plurality of image generating units such that the time necessary for image generation processing in any of the image generating units does not exceed the time necessary to form an image by said image forming unit from output format image data in a number of blocks corresponding to the width of said original image data when the plurality of image generating units execute in parallel image generation processing of a block corresponding to the width of said original image data.

6. A control method for an image processing device executed by the image processing device, comprising:
a dividing step of dividing original image data into a plurality of blocks;
an attribute determining step of determining a block attribute for each divided block;
a predicting step of calculating a predicted amount of time necessary for image generation processing that generates output format image data suitable for an image forming unit from said original image data based on the block attribute and the processing time of a block unit;
a preparation processing step of converting image data of any of said plurality of blocks to suitable image data having a block attribute that has a shorter processing time such that image generation processing of said plurality of blocks will be complete within said predetermined time, in the case that said predicted time exceeds a predetermined amount of time;
a sorting step of sorting suitable image data of each said block to a plurality of image generating units that generate said output format image data in units of blocks; and
a rearranging step of rearranging the output format image data in units of blocks generated by said image generating units to positions corresponding to said original image data before division.

7. A computer executable program for causing a computer to execute the control method for an image processing device according to claim 6.

8. An image processing apparatus, comprising:
division means for dividing input image data into a plurality of blocks;
attribute determination means for determining a block attribute for each divided block;
calculation means for calculating a predicted amount of time necessary for image generation processing that generates image data to be output from the input image data based on the block attribute and the processing time of a block unit;
conversion means for converting image data of a block of the plurality of blocks into bitmap data so as to complete the image generation process for the plurality of blocks within a predetermined time frame when the predicted amount of time exceeds time needed to complete output from an engine; and
change means for changing the block attribute converted into bitmap data by said conversion means.

9. An image processing method, comprising the steps of:
dividing input image data into a plurality of blocks;
determining a block attribute for each divided block;
calculating a predicted amount of time necessary for image generation processing that generates image data to be output from the input image data based on the block attribute and the processing time of a block unit;
converting image data of a block of the plurality of blocks into bitmap data so as to complete the image generation process for the plurality of blocks within a predetermined time frame when the predicted amount of time exceeds time needed to complete output from an engine; and
changing the block attribute converted into bitmap data in the converting step.
